(19) United States
(12) Patent Application Publication
(10) Pub. No.: US 2022/0057077 A1
(43) Pub. Date: Feb. 24, 2022

(54) Modular Light Emitting Diode Fixture Having Enhanced Wiring For Modular Components

(71) Applicant: Lake and Wells, LLC, Carrboro, NC (US)

(72) Inventor: Mark Anthony Kinsley, Chapel Hill, NC (US)

(21) Appl. No.: 17/388,782

(22) Filed: Jul. 29, 2021

Related U.S. Application Data
(60) Provisional application No. 63/059,611, filed on Jul. 31, 2020.

(51) Int. Cl. F21V 23/06; F21S 2/00; F21V 23/02

(52) U.S. Cl. CPC F21V 23/06; F21Y 2103/10; F21V 23/02; F21S 2/005

(57) ABSTRACT

The present disclosure relates to modular LED fixtures that have improved lighting harnesses to provide power downstream with less power loss by bypassing upstream lighting devices.

### CROSS-REFERENCE TO RELATED APPLICATIONS

This application claims the benefit of U.S. Provisional Application No. 63/059,611, filed Jul. 31, 2020, and is incorporated by reference herein in its entirety.

### FIELD

The following disclosure relates to modular light emitting diode (LED) fixtures and, specifically, to modular LED fixtures having enhanced wiring for connecting modular components of a modular LED fixture.

### BACKGROUND

Since their inception incandescent light bulbs and other non-polar light emitting elements have dominated the marketplace for lighting elements. The recent trend sees LED lighting elements displacing incandescent bulbs and other conventional lighting elements. Thus, there is an increased demand for LED light fixtures.

LED light fixtures operate using direct current (DC), and for that reason, they are fundamentally different than fixtures that use alternating current (AC) such as, for example, incandescent bulbs. Incandescent bulbs can produce a constant light source in response to an alternating current. If an incandescent light bulb is connected to an AC power source, the direction of the current flowing across the incandescent lighting element changes each time the polarity of voltage across the terminals of the incandescent lighting element flips. Because of this, the incandescent lighting element of the incandescent light bulb can be modelled as a resistor. A resistor is a non-polar circuit element, and thus, the incandescent light bulb will produce light continuously and in proportion to the heat dissipated across the incandescent lighting element regardless of the direction of the current flowing through the resistor.

As opposed to the incandescent lighting elements, LED lighting elements are polar, and therefore, only produce light when a voltage of the proper polarity (forward bias) is applied to the LED lighting element causing current to flow in the proper direction to produce light. Fundamentally, an LED is a semiconductor device having a PN-junction and light will be produced when free electrons flow from the N-type region and into the P-type region, allowing the free electrons to combine with positive charge carriers that are travelling from the P-type region to the N-type region. When a free electron combines with positive charge carrier in an LED lighting element, the free electron falls from a higher energy orbital to a lower energy orbital, and as a result, the LED lighting element emits energy in the form of light.

When the polarity of the voltage source attached to an LED flips (is reverse biased), free electrons cannot combine with positive charge carriers and light will not be produced by the LED lighting element, or in other words, current will neither flow through the LED lighting element nor produce light. Thus, the effect of connecting an LED lighting element to an AC power source is that the LED will blink, and blinking is a very undesirable quality for light fixtures designed to provide a continuous light source. To address this problem, LED light fixtures include power converters that convert AC power from the grid to DC power desirable for powering LED light fixtures.

LEDs are very sensitive to reversed bias current and will burn out if too much current is made to flow when the LED lighting element is operating in a reversed bias mode. Thus, it is critical that modular LED lighting fixtures are installed with all LED lighting elements having a forward bias. Typically, properly biasing each LED is achieved through painstaking and time-consuming manual wiring of an LED light fixture.

LEDs also consume relatively considerable power. For example, in a long strip of LEDs in series, the light from the LEDs farthest from the power source may be dim or not lit at all. This can be a problem in modular lighting fixtures with a number of LEDs and LED strips positioned in series.

Therefore, there is a need for LED light fixtures that can be quickly installed and avoid the need to manually wire each LED element during installation. This desire includes being able to prevent installation of LED elements in a reversed bias and, thus, eliminate installation error and decrease installation time. This desire further includes being able to wire modular fixtures in a fast and convenient method that does not jeopardize proper lighting to be provided by LED's downstream from the power source due to voltage drops. It is further desired to reduce shipping cost for these lighting fixtures.

### BRIEF DESCRIPTION OF THE DRAWINGS

FIG. 1 is a perspective view of a modular LED fixture;

FIG. 2a is a top perspective view of a power supply hub;

FIG. 2b is a bottom perspective view of the power supply hub of FIG. 2a;

FIG. 3a is a top perspective view of an anchor hub;

FIG. 3b is a bottom perspective view of the anchor hub of FIG. 3a;

FIG. 4a is a perspective view of a single LED light beam;

FIG. 4b is a cross-section view of a portion of single LED light beam of FIG. 4a;

FIG. 4c is an end perspective view of the single LED light beam of FIG. 4a;

FIG. 5a is a perspective view of a dual LED light beam;

FIG. 5b is a cross-section view of a portion of the dual LED light beam of FIG. 5a;

FIG. 5c is an end perspective view of the dual LED light beam of FIG. 5a;

FIG. 6a is a perspective view of a non-lighted beam;

FIG. 6b is a cross-section view of a portion of the non-lighted beam of FIG. 6a;

FIG. 6c is an end perspective view of the non-lighted light bam of FIG. 6a;

FIG. 7a is a perspective view of a two-connection hub;

FIG. 7b is a cross-section view of the two-connection hub of FIG. 7a;

FIG. 7c is perspective view of wiring for the two-connection hub of FIG. 7a;

FIG. 8a is a perspective view of another two-connection hub;

FIG. 8b is a cross-section view of the two-connection hub of FIG. 8a;

FIG. 9a is a perspective view of a three-connection hub;

FIG. 9b is a cross-section view of the three-connection hub of FIG. 9a;

FIG. 9c is a perspective view of wiring for the three-connection hub of FIG. 9a;

FIG. 10a is a perspective view of a another three-connection hub;

FIG. 10b is a cross-section view of the three-connection hub of FIG. 10a;

FIG. 11a is a perspective view of a four-connection hub;

FIG. 11b is a cross-section view of the four-connection hub of FIG. 11a;

FIG. 11c is a perspective view of wiring for the four-connection hub of FIG. 11a;

FIG. 12a is a perspective view of another four-connection hub;

FIG. 12b is a cross-section view of the four-connection hub of FIG. 12a;

FIG. 13a is a perspective view of a five-connection hub;

FIG. 13b is a cross-section view of the five-connection hub of FIG. 13a without wiring;

FIG. 13c is a perspective view of wiring for the five-connection hub of FIG. 13a;

FIG. 14a is a perspective view of six-connection hub;

FIG. 14b is a cross-section view of the six-connection hub of FIG. 14a without internal wiring;

FIG. 14c is a perspective view of writing for the six-connection hub of FIG. 14a;

FIG. 15a is a perspective view of a subassembly of a modular LED lighting fixture;

FIG. 15b is an exploded perspective view of the subassembly of the modular LED lighting fixture of FIG. 15a;

FIG. 16a is an exploded perspective view of another subassembly of a modular LED lighting fixture;

FIG. 16b is a cross-section view of the subassembly of the modular LED lighting fixture of FIG. 16a;

FIG. 16c is another cross-section view of the subassembly of the modular LED lighting fixture of FIG. 16a;

FIG. 17 is a plan view of a wire harness with a single LED strip;

FIG. 18 is a plan view of a wire harness with two LED strips;

FIG. 19 is a plan view of another wire harness with two LED strips; and

FIG. 20 is a plan view of another wire harness with two LED strips.

### DETAILED DESCRIPTION

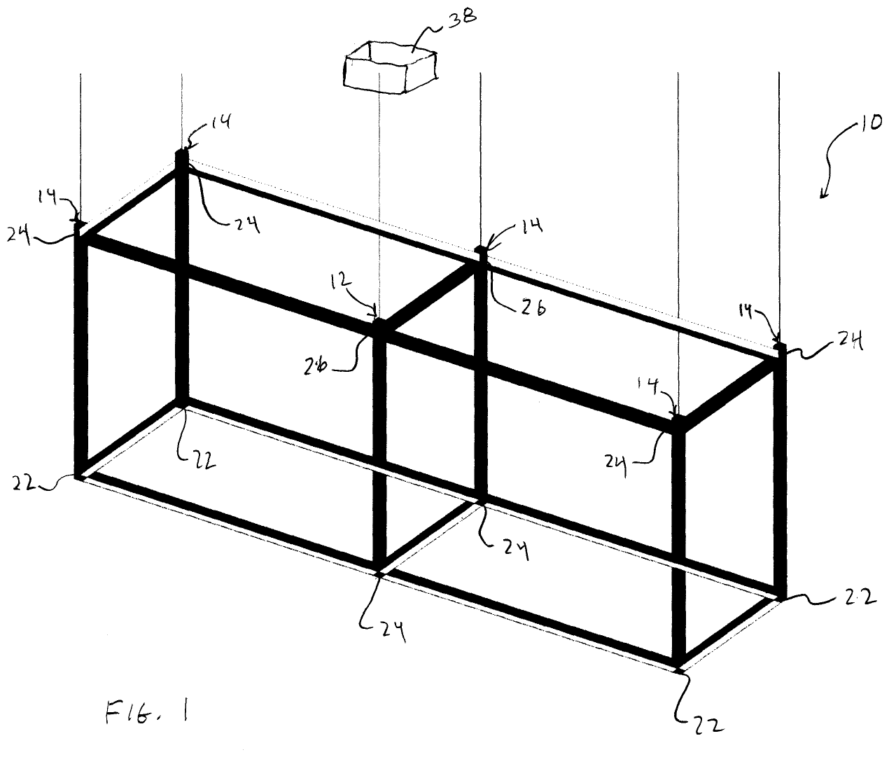

FIG. 1 illustrates a modular LED light fixture 10. This type of modular LED light fixture can be quickly assembled and installed because it avoids having to manually wire each LED element and prevents installation of LED elements in a reversed bias configuration. Further, because these LED fixtures are modular, they can easily be shipped, and the need to assemble the LED light fixtures before shipping is eliminated.

As explained further herein, a modular LED light fixture of this type requires DC power. So, there is a converter that converts AC power to DC power. One or more connecting elements may connect a power source to LED lighting elements of the modular LED light fixture. For instance, a hub may be coupled to the power source. The hub will have at least one power connecting element. A light emitting diode lighting circuit device containing an LED lighting element may be coupled to the power source through the power connecting element. The light emitting diode lighting circuit device has, for example, at least one LED lighting element, such as a light emitting diode, at least one power connecting element, and a polarity circuit. The polarity circuit is configured to maintain the voltage across the at least one light emitting diode in a first polarity regardless of the polarity of the voltage across a corresponding power connecting element.

The power connecting element of the light emitting diode lighting circuit device may have contact elements that are either pins or pads for coupling with the pins or pads of a power connecting element. If the power connecting element has pins, then it will couple with a power connecting element that has pads and vice versa. The mechanical coupling of the pins and pads also serves as an electrical coupling to power the LED lighting elements. The light emitting diode lighting circuit device is powered by contact between at least two pins and at least two pads, and the pins have a non-flat terminal end, such as a substantially round or hemispherical terminal end, for contacting the pads. The substantially rounded or hemispherical terminal end or head provides superior electrical conductivity.

As disclosed further herein, the light emitting diode lighting circuit device may include a bypass wire to extend the full power of the power input beyond the current LED to the next component. The bypass wire is also able to power the next LED or polarity circuit with specifically divided positive and negative outputs.

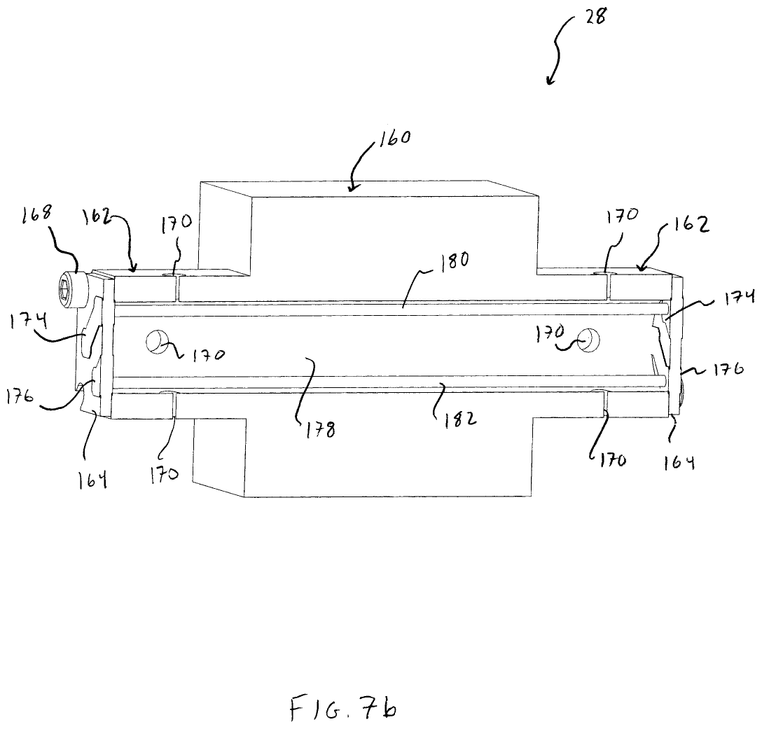

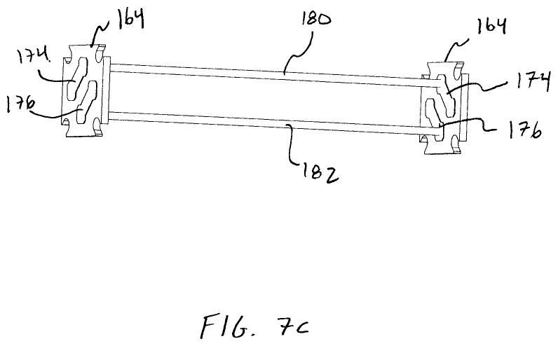

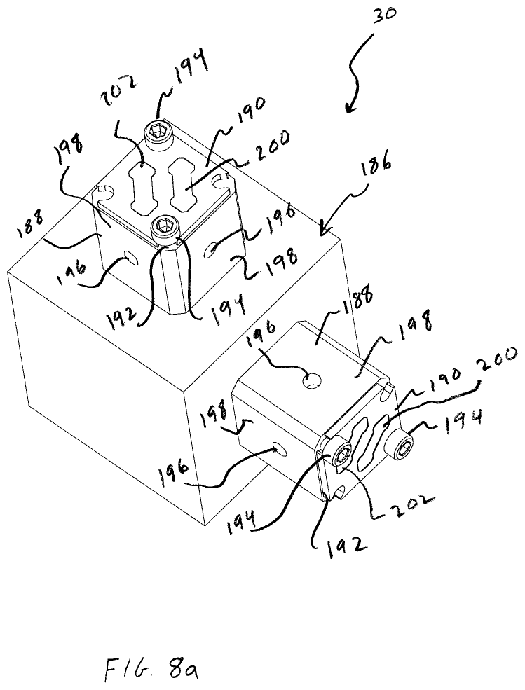

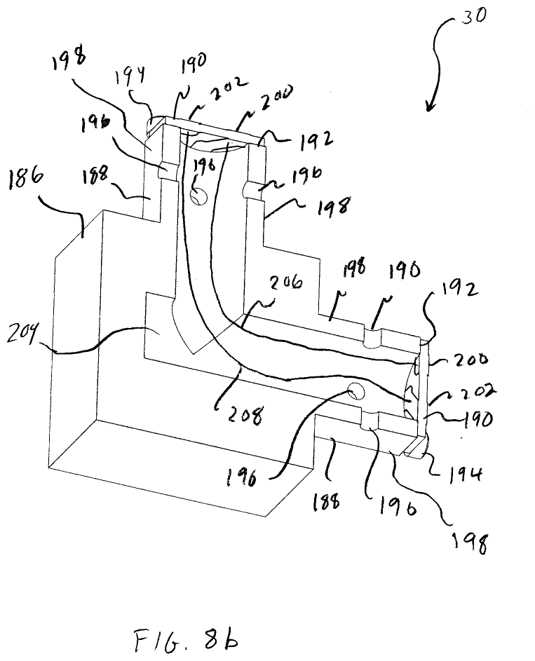

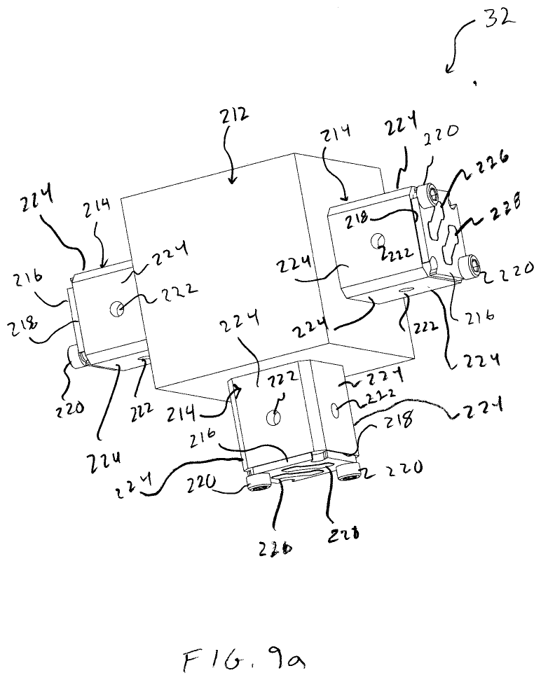

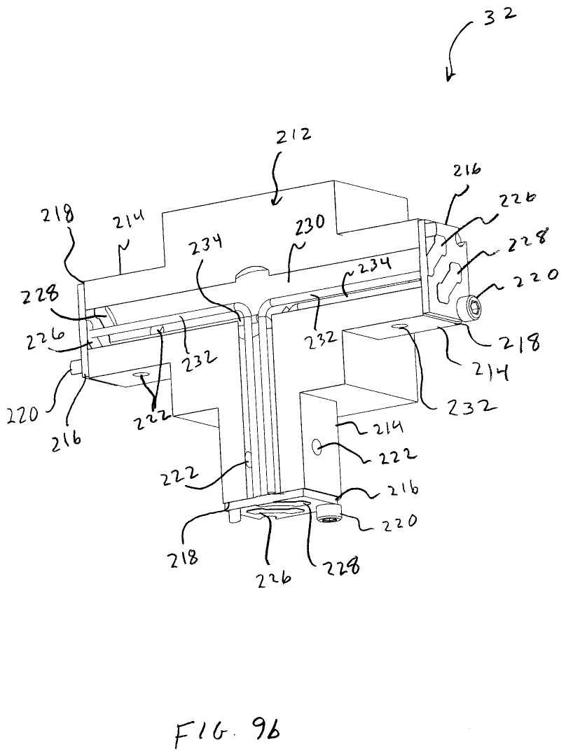

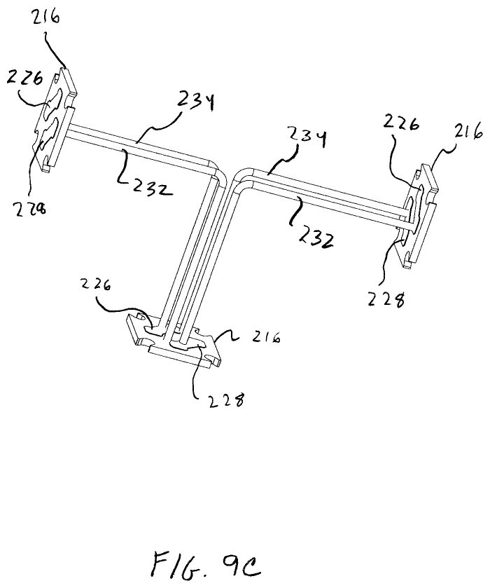

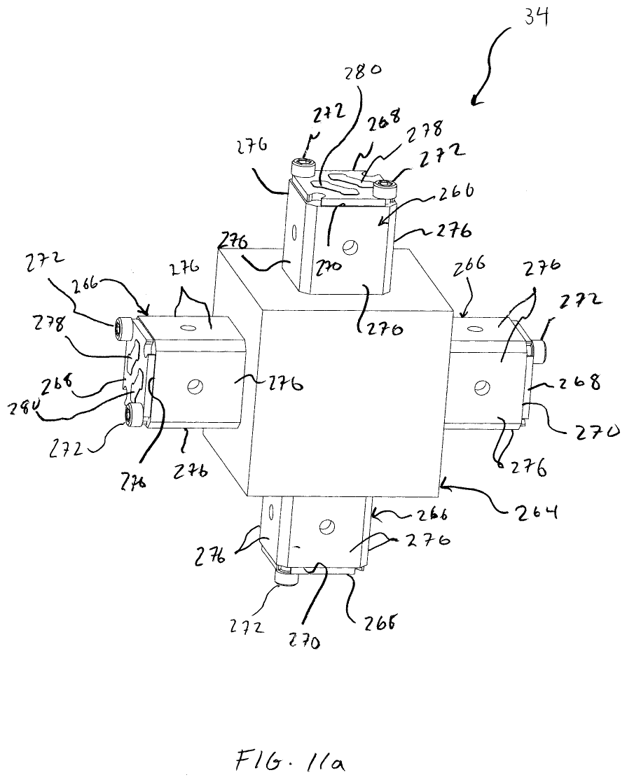

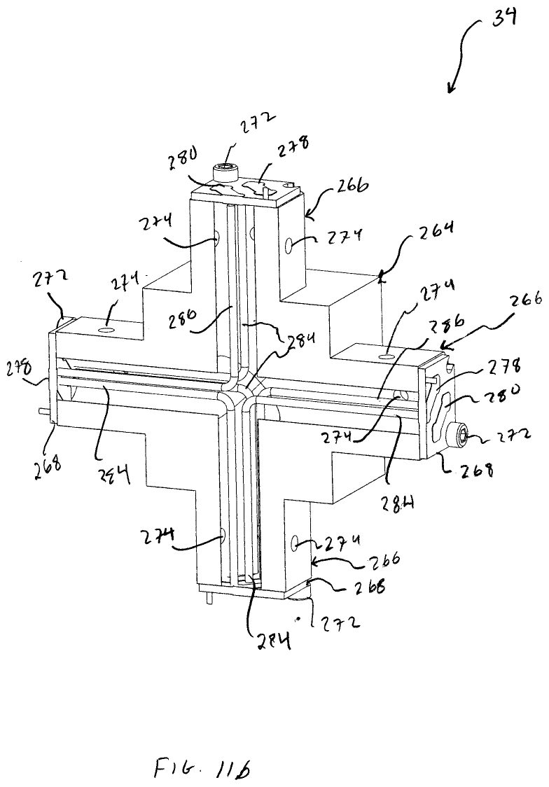

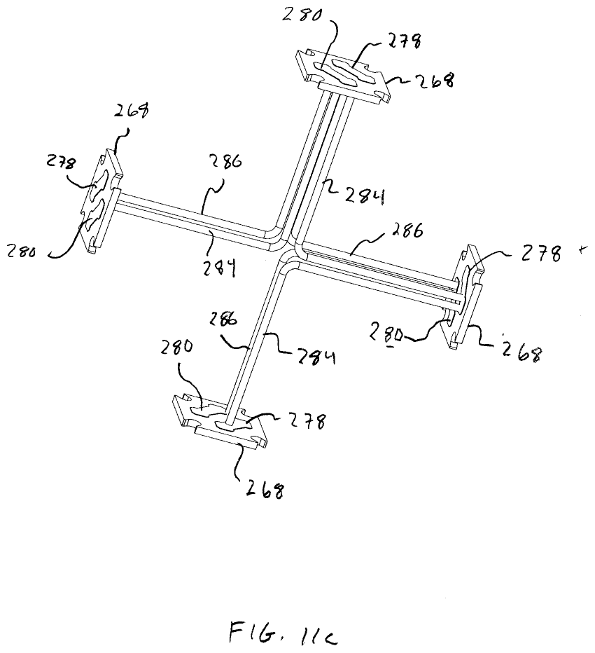

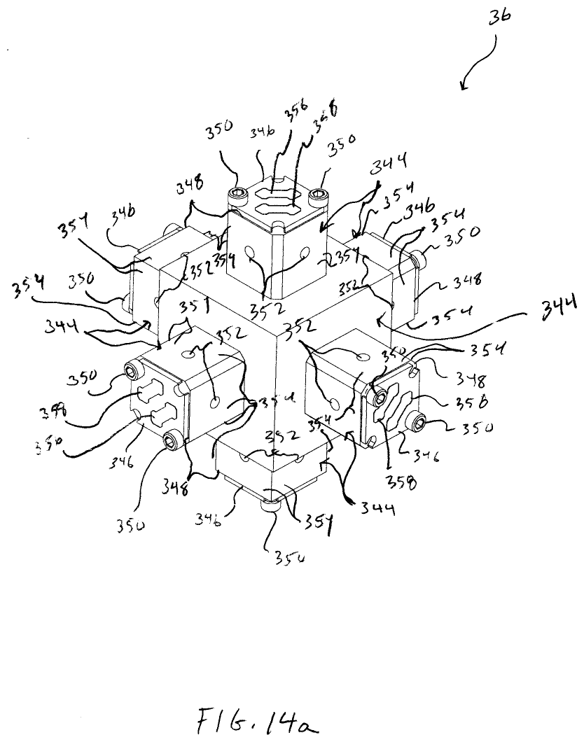

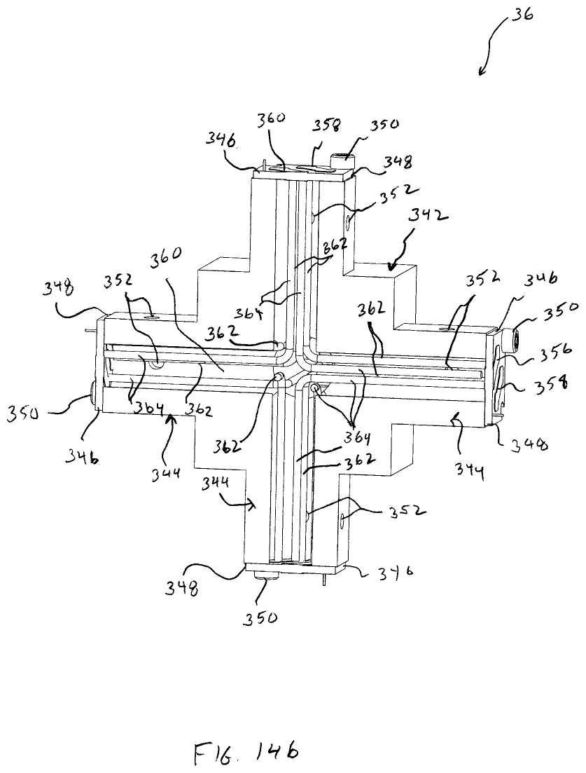

With reference to FIG. 1, the modular LED light fixture 10 is supported by one or more power supply hubs 12 and anchor hubs 14 being connected to an overhead structure and the light fixture 10. The light fixture 10 includes single LED light beams 16, dual light beams 18 and non-lighted beams 20. Three connection hubs, 22, four connection hubs 24 and five connection hubs 26 interconnect the beams 16, 18, 20. The fixture 10 takes on the shape of rectangular box. It could however take on other configurations and use additional hub types, such as straight through two-connection hub 28 (FIGS. 7a-7c), a 90 degree two-connection hub 30 (FIGS. 8a and 8b), a T-configured three-connection hub 32 (FIGS. 9a- 9c), a plus-sign four connection hub 34 (FIGS. 11a-11c), and a six connection hub 36 (FIGS. 14a-14c).

A power converter 38 connects to the power supply hub 12. The power converter is further shown and described in U.S. Pat. No. 11,067,256 to Kinsley entitled “MODULAR LIGHT EMITTING DIODE FIXTURE HAVING ENHANCED INTERCONNECT PINS BETWEEN MODULAR COMPONENTS”, which is incorporated by reference in its entirety herein. The power converter 38 converts AC power as an input to and DC power as an output that can be sued by the modular LED light fixture 10. The power converter 38 may be configured to convert the AC power to have any appropriate DC voltage level for powering the modular LED light fixture 10. For example, the power converter 38 may output power at 12, 18, or 24 volts. Alternatively, a requisite power converter may be further embodied as part of a residential or commercial infrastructure.

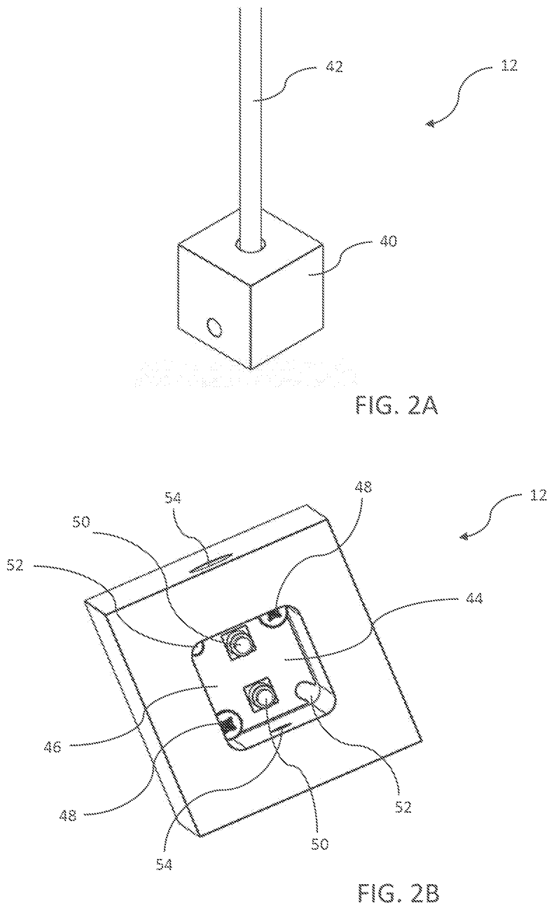

As illustrated in FIGS. 2a and 2b, the power supply hub 12 includes a body 40 attached to an electrical and support wire 42. The body 40 defines a socket 44 with a rectangular cross-section and a printed circuit board 46 attached to its bottom with a pair of diametrically opposed screws 48. A pair of pins 50 extend into the socket 44 from the printed circuit board 46.

As explained further herein, the socket 44 receives a plug of another node that includes wire contacts of a light harness. The socket 44 further defines a pair of diametrically opposed alignment holes 52 for receiving alignment pins of another hub or beam. The supply node 12 defines a pair of screw holes 16 on opposite sides of the body 13 that receive screws to secure the power supply node 12 to another node or beam.

The wire 42 couples the power converter 38 to the power supply node 12. The wire 14 may be any commercially available wire adequate to support the electrical current electrical and physical weight of the LED light fixture 10. The wire 42 may be mechanically coupled to the power supply node 12. The mechanical couple between the wire 42 and the power supply node 12 may be with a mechanical gripping of the wire or other method, such as using an adhesive affixing the wire 14 to the power supply node 12.

The wire 14 may include both an inner wire or wires for creating an electrical connection between the converter 38 and the power supply hub 12 and an outer shield and/or supporting wire capable of bearing the weight of the LED light fixture 10. In this case, the outer shield or supporting wire may be mechanically coupled to the power converter 38 for the purpose of supporting the LED light fixture 10, and the inner wire or wires will be coupled to the power converter 38 merely for establishing an electrical connection between the power converter 38 and the power supply node 12. In some cases, the weight may be distributed between the inner wire or wires and the sheath or support wire. In such a case, the inner wire or wires will be electrically and mechanically coupled to the power converter 38 such that they are each capable of bearing a portion of the weight of the LED light fixture 10 without compromising the electrical connection between the power converter 38 and the power supply node 12.

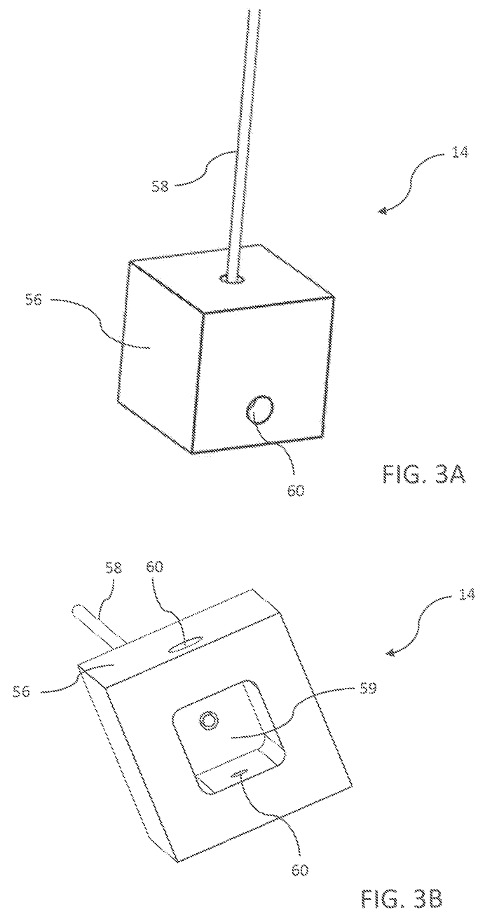

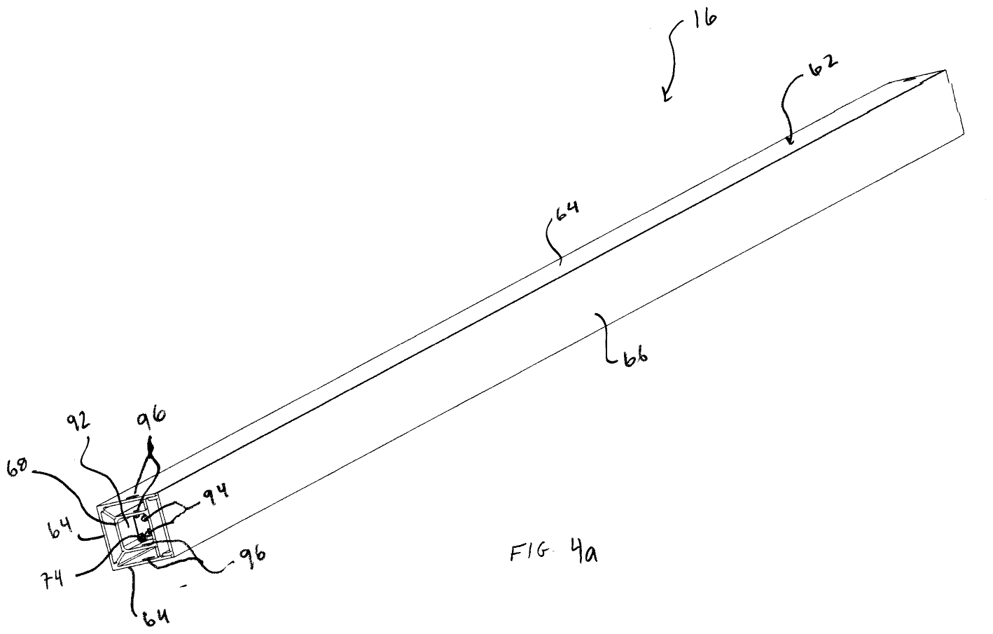

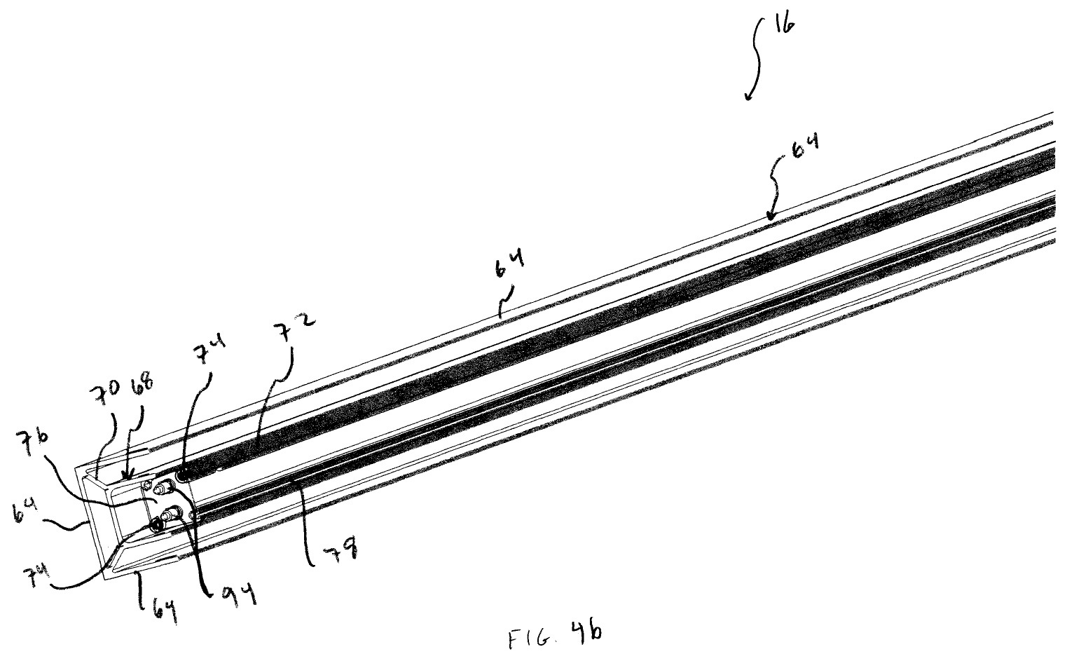

With reference to FIGS. 3a and 3b, an anchor hub 14 is illustrated with a body 56 attached to an anchor wire 58. The anchor hub 14 is used to support the modular light fixture 10. There are five anchor hubs 14 and one power supply hub 12 supporting the modular light fixture 10. The breakdown between the number of power supply hubs 12 and anchor hubs 14 can vary depending on the power needs of a light fixture. The anchor wire 58 is securely attached to the body 56 of the anchor hub 14 with a mechanically attachment or an adhesive attachment. The body 56 also defines a rectangular cross-section socket 59 that receives a plug of another hub. The anchor hub 14 defines a pair of opposing screw holes 60 that receive screws to secure the anchor hub 14 to another node.

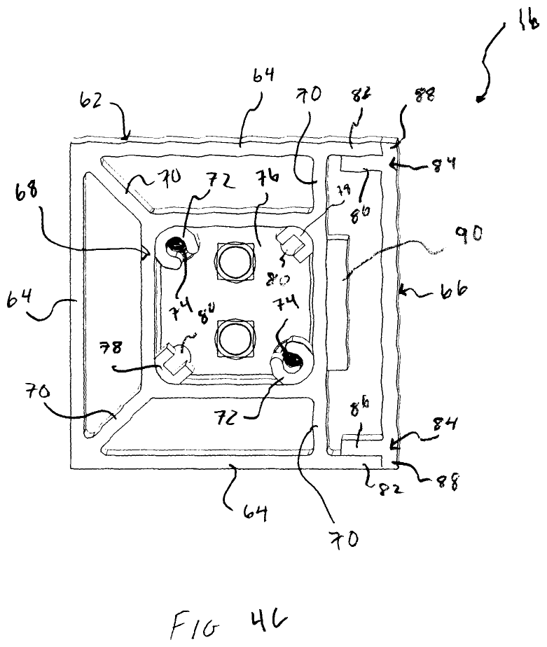

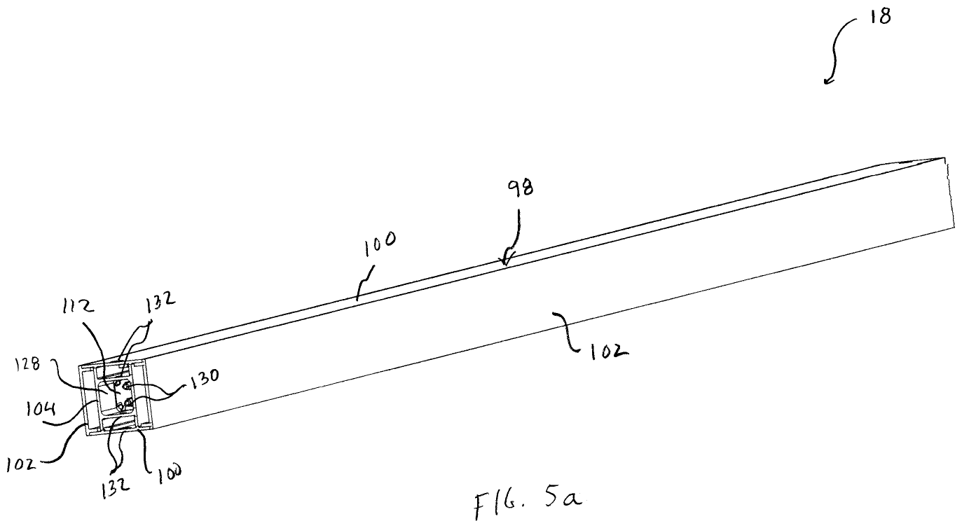

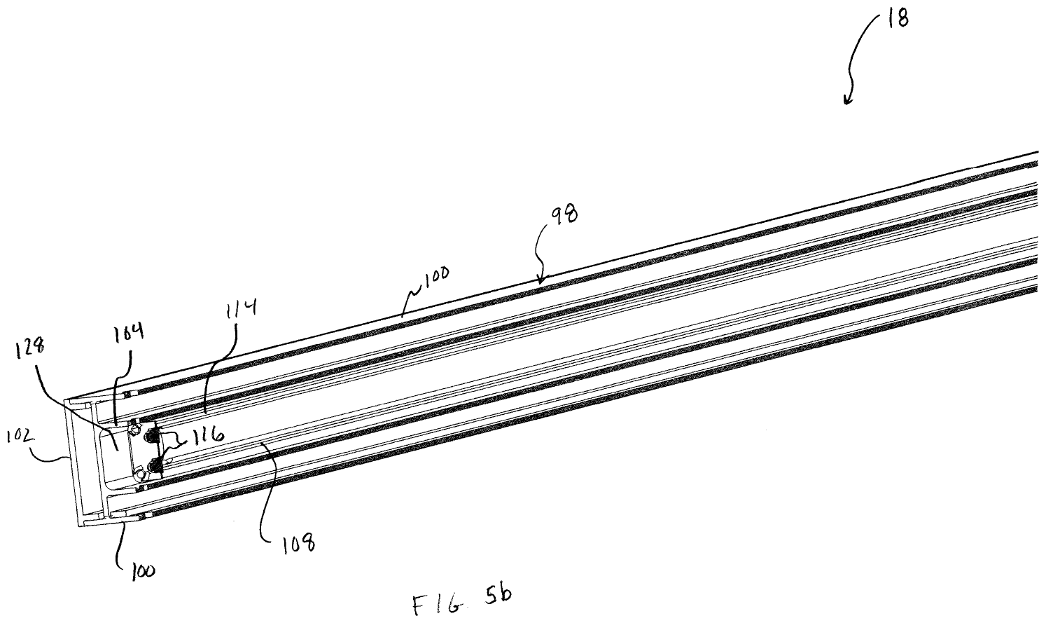

As shown in FIGS. 4a-4c, there is illustrated a single LED light beam 16. The light beam 16 includes an elongated body 62 with a rectangular cross-section. The elongated body 62 may be extruded. The elongated body 62 has three opaque outer elongated sides 64. An elongated lens 66 extends along the elongated body 62 and affixes to the body 62 with a snap fit, adhesive or a weld. The body 62 is either transparent our translucent. The elongated body 62 includes an inner elongated, rectangular hub 68. Four elongated webs 70 connect the inner hub 68 to the outer sides 64. At inner corners of the inner hub 68, there are diagonally opposed elongated, C-shaped grooves 72 for receiving screws 74 to mount a printed circuit board 76 in the beam 16 and diagonally opposed elongated U-shaped grooves 78 to receive alignment pins 80 of the printed circuit board 76.

Two of the outer sides 64 includes extensions 82 that engage the lens 66. More specifically, the lens 66 includes opposing T-shaped elongated edges 84. One leg 86 engages an inside of the extension 82 of the body 62, and another leg 88 engages an end of the extension 90. A light emitting diode strip 90 is affixed to the outside of the inner hub 68 to run along the lens 66 so that light from the strip 90 illuminates the lens 66.

The inner hub 68 defines a socket 92 to receive a plug of a node, as described below. The elongated c-shaped grooves 72 and the elongated U-shaped grooves 78 are setback from ends of the elongated body 62. The printed circuit board 76 includes a pair of pins 94 projecting longitudinally into the socket 92. The pins 94 make electrical contact with corresponding flat contacts on a node inserted into the socket 92. Opposing outer sides 64 and the inner hub 68 include a pair of aligned holes 96 that receive screws that engage a node to hold the node in the socket 92 against unintentional removal.

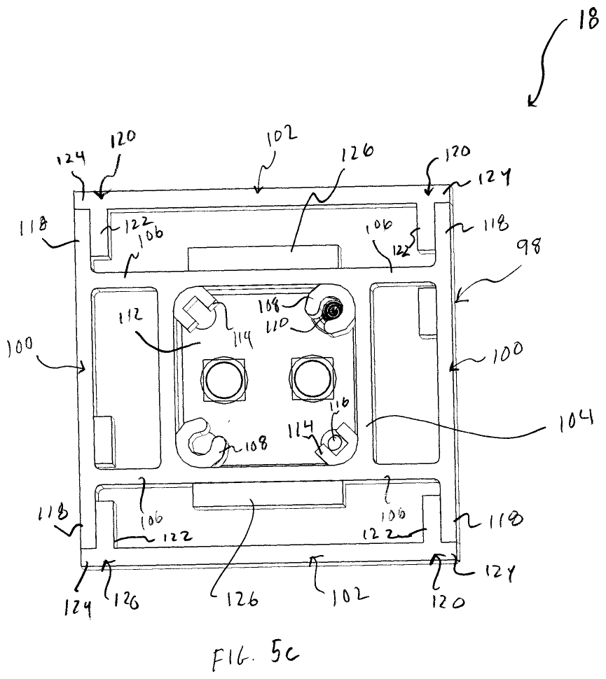

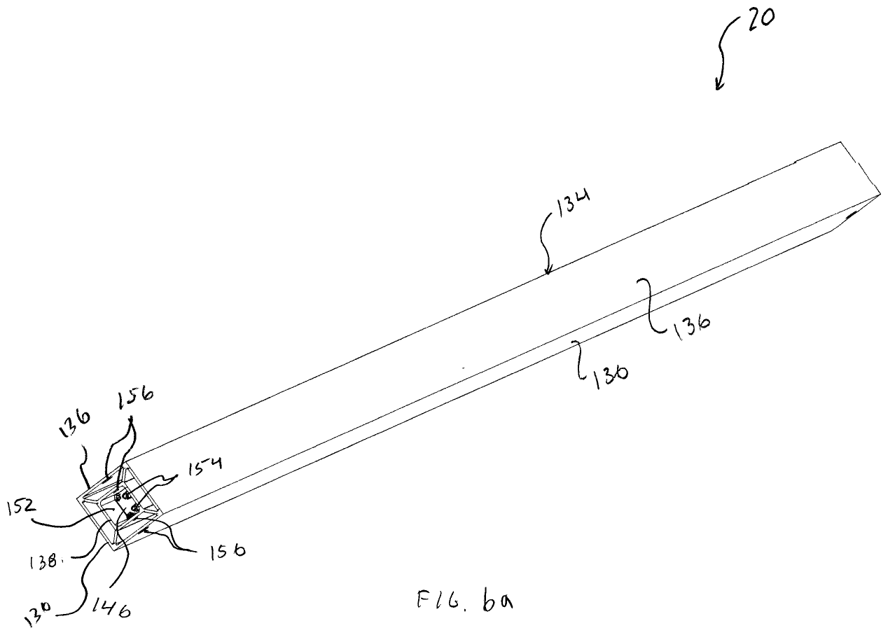

With reference to FIGS. 5a-5c, there is illustrated the dual light beam 18. The light beam 18 includes an elongated body 98 with a rectangular cross-section and may be extruded. The elongated body 98 has two opaque outer elongated sides 100. Two elongated lenses 102 extend along the elongated body 98 and are affixed to the body 98 with a snap fit, adhesive or a weld. The lenses 102 are either transparent our translucent.

The elongated body 98 includes an inner elongated, rectangular hub 104. Four elongated webs 106 connect the inner hub 104 to the outer sides 100. At inner corners of the inner hub 104, there are diagonally opposed elongated, C-shaped grooves 108 for receiving screws 110 to mount a printed circuit board 112 in the beam 18 and diagonally opposed elongated U-shaped grooves 114 to receive alignment pins 116 of the printed circuit board 112.

The outer sides 100 include extensions 118 that engage the lenses 102. More specifically, the lenses 102 include opposing T-shaped elongated edges 120. A first leg 122 of the edges 120 engages an inside of the extension 118 of the body 62, and another leg 124 engages an end of the extension 118. Light emitting diode strips 126 are affixed to the outside of the inner hub 68 to run along the lenses 100 so that light from the strips 126 illuminates the lenses 100.

The inner hub 104 defines a socket 128 to receive a plug of a node, as described below. The elongated c-shaped grooves 108 and the elongated U-shaped grooves 114 are setback from ends of the elongated body 98. The printed circuit board 112 includes a pair of pins 130 projecting longitudinally into the socket 128. The pins 130 make electrical contact with corresponding flat contacts on a node inserted into the socket 128. The outer sides 199 and the inner hub 104 include a pair of aligned holes 132 that receive screws that engage a node to hold the node in the socket 128 against unintentional removal.

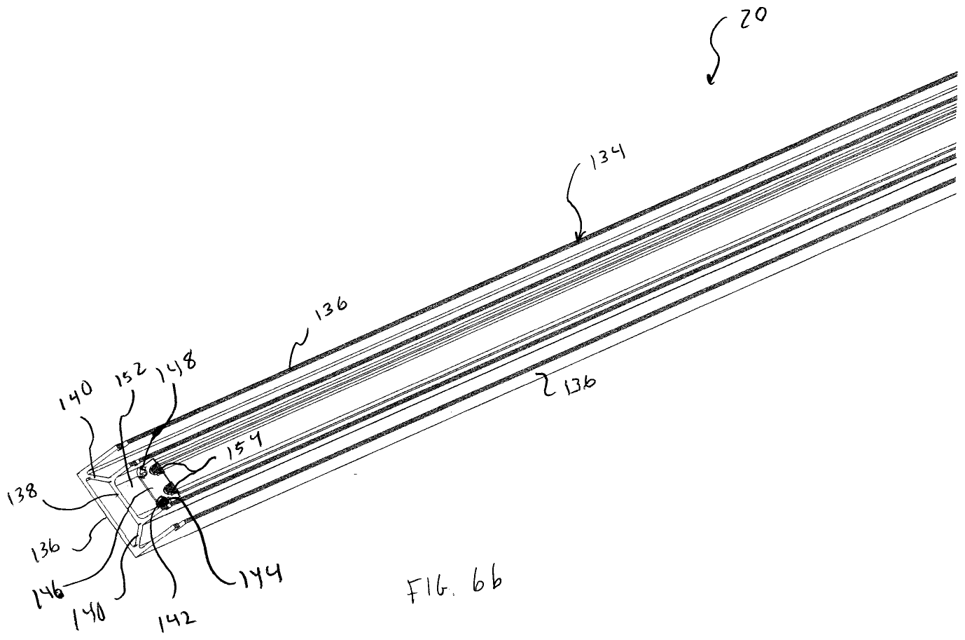

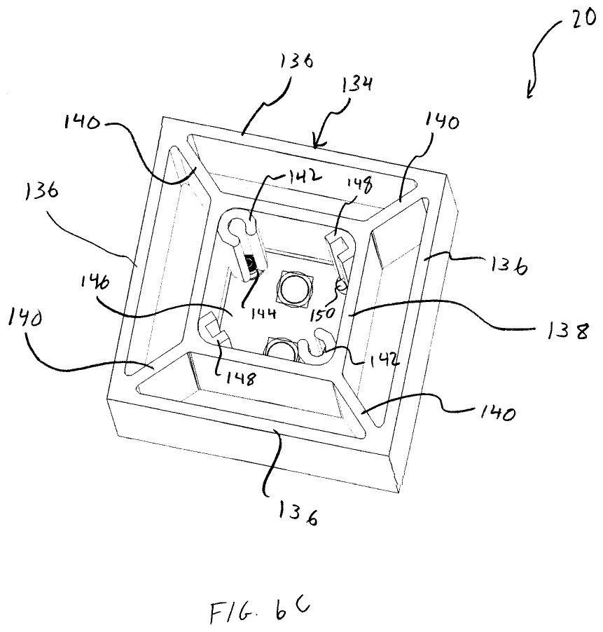

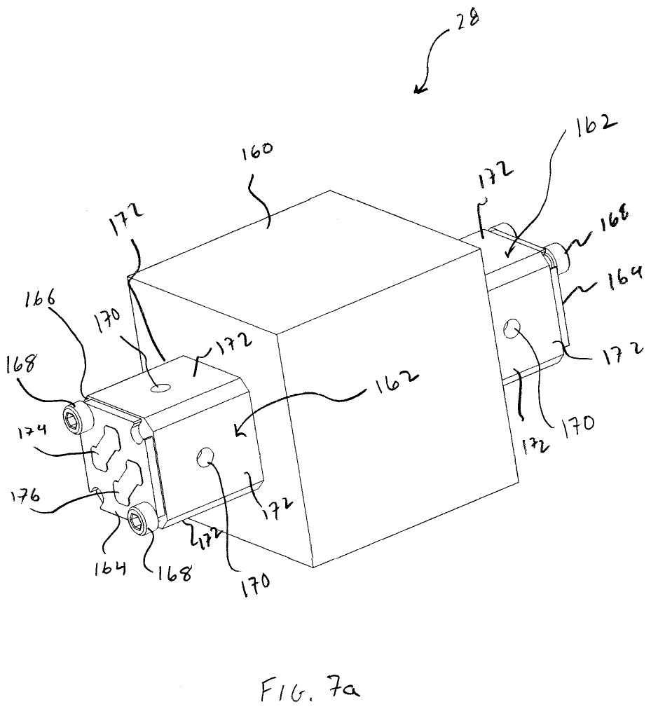

As shown in FIGS. 6a-6c, there is illustrated a non-lighted beam 20. The non-lighted beam 20 includes an elongated body 134 with a rectangular cross-section and may be extruded. The elongated body 134 has four opaque outer elongated sides 136. The elongated body 134 includes an inner elongated, rectangular hub 138. Four elongated webs 140 connect the inner hub 138 to the outer sides 136. At inner corners of the inner hub 138, there are diagonally opposed elongated, C-shaped grooves 142 for receiving screws 144 to mount a printed circuit board 146 in the beam 20 and diagonally opposed elongated U-shaped grooves 148 to receive alignment pins 150 of the printed circuit board 146.

The inner hub 138 defines a socket 152 to receive a plug of a node, as described below. The elongated c-shaped grooves 142 and the elongated U-shaped grooves 148 are setback from ends of the elongated body 134. The printed circuit board 146 includes a pair of pins 154 projecting longitudinally into the socket 152. The pins 154 make electrical contact with corresponding flat contacts on a node inserted into the socket 152. The outer sides 136 and the inner hub 138 include a pair of aligned holes 156 that receive screws that engage a node to hold the node in the socket 152 against unintentional removal.

Regarding FIGS. 7a-7c, there is illustrated the two-connection hub 28. The two-connection hub 28 includes a rectangular body 160 supporting two plugs 162 extending from the body 160 at 180 degrees from one another. The plugs 162 also are rectangular in shape. Each plug 162 includes a printed circuit board 164 attached to its outward face 166 with screws 168. Each plug 162 includes holes 170 through each of four sidewalls 172 that are used with screws and the holes of the beams to secure the hub 158 to the beams 16, 18, 20.

The printed circuit boards 164 include positive and negative flat contacts 174, 176. The plugs 162 and the body 160 define an internal cavity 178. Positive and negative wires 180, 182 extend through the cavity 178 to interconnect the positive and negative flat contacts 174, 176.

As shown in FIGS. 8a and 8b, there is illustrated the two-connection hub 30. The two-connection hub 30 includes a rectangular body 186 supporting two plugs 188 extending from the body 186 at 90 degrees from one another. The plugs 188 also are rectangular in shape. Each plug 188 includes a printed circuit board 190 attached to its outward face 192 with screws 194. Each plug 188 includes holes 196 through each of four sidewalls 198 that are used with screws and the holes of the beams 16, 18, 20 to secure the hub 184 to the beams 16, 18, 20.

The printed circuit boards 190 include positive and negative flat contacts 200, 202. The plugs 188 and the body 186 define an internal cavity 204. Positive and negative wires 206, 208 extend through the cavity 204 to interconnect the positive and negative flat contacts 200, 202.

With reference to FIGS. 9a-9c, there is illustrated the three-connection hub 32. The three-connection hub 32 includes a rectangular body 212 supporting three plugs 214 extending from the body 212 in a T-shaped configuration. The plugs 214 also are rectangular in shape. Each plug 214 includes a printed circuit board 216 attached to its outward face 218 with screws 220. Each plug 214 includes holes 222 through each of four sidewalls 224 that are used with screws and the holes of the beams 16, 18, 20 to secure the hub 210 to the beams 16, 18, 20.

The printed circuit boards 216 include positive and negative flat contacts 226, 228. The plugs 214 and the body 212 define an internal cavity 230. Positive and negative wires 232, 234 extend through the cavity 204 to interconnect the positive and negative flat contacts 226, 228.

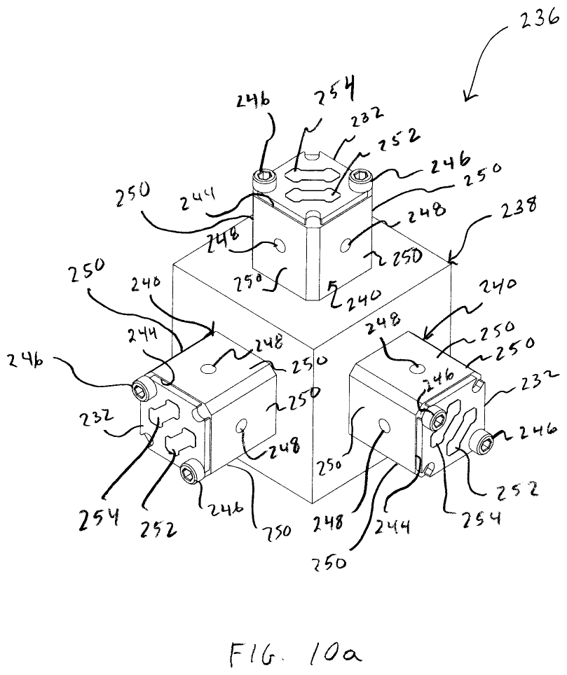

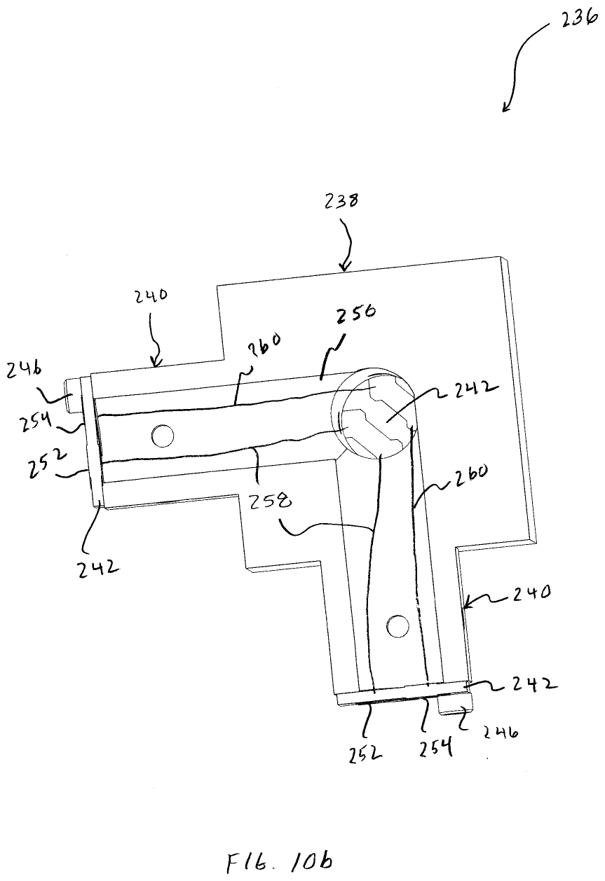

With reference to FIGS. 10a and 10b, there is illustrated another three-connection hub 236. The three-connection hub 236 includes a rectangular body 238 supporting three plugs 240 extending from the body 238, each at a right angle to one another. The plugs 240 also are rectangular in shape. Each plug 240 includes a printed circuit board 242 attached to its outward face 244 with screws 246. Each plug 240 includes holes 248 through each of four sidewalls 250 that are used with screws and the holes of the beams 16, 18, 20 to secure the hub 236 to the beams 16, 18, 20.

The printed circuit boards 242 include positive and negative flat contacts 252, 254. The plugs 240 and the body 238 define an internal cavity 256. Positive and negative wires 258, 260 extend through the cavity 256 to interconnect the positive and negative flat contacts 252, 254.

As shown in FIGS. 11a-11c, there is illustrated the four-connection hub 34. The four-connection hub 34 includes a rectangular body 264 supporting four plugs 266 extending from the body 264 in a plus sign configuration. The plugs 266 also are rectangular in shape. Each plug 266 includes a printed circuit board 268 attached to its outward face 270 with screws 272. Each plug 266 includes holes 274 through each of four sidewalls 276 that are used with screws and the holes of the beams 16, 18, 20 to secure the hub 262 to the beams 16, 18, 20.

The printed circuit boards 268 include positive and negative flat contacts 278, 280. The plugs 266 and the body 238 define an internal cavity 282. Positive and negative wires 284, 286 extend through the cavity 282 to interconnect the positive and negative flat contacts 278, 280.

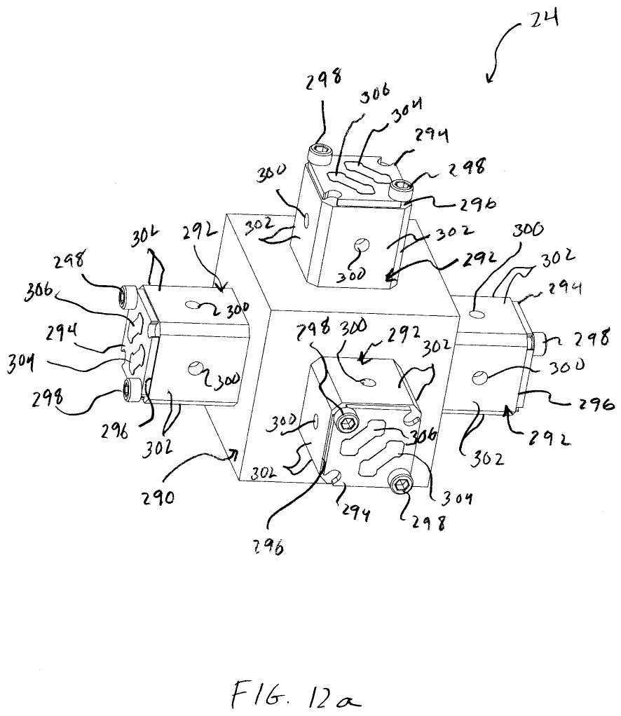

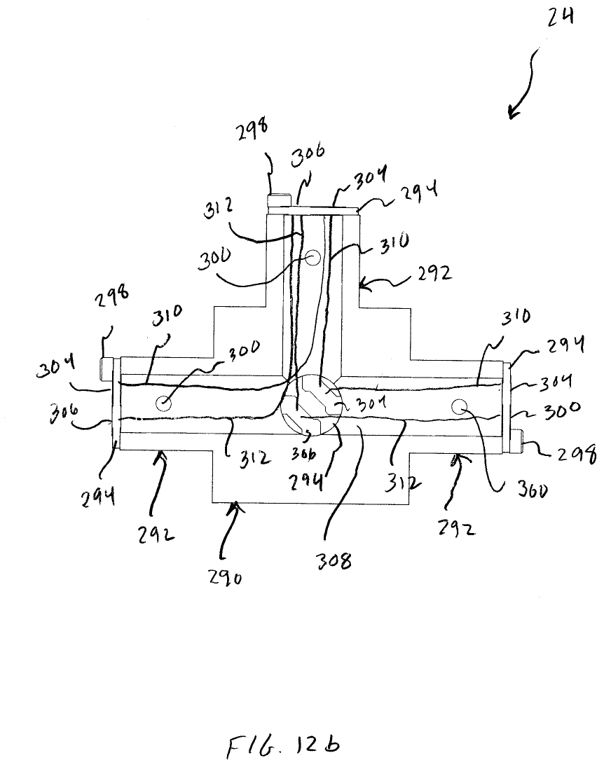

With reference to FIGS. 12a and 12b, there is illustrated another four-connection hub 288. The four-connection hub 288 includes a rectangular body 290 supporting four plugs 292 extending from the body 290, each plug 292 being 90 degrees from another. The plugs 292 also are rectangular in shape. Each plug 292 includes a printed circuit board 294 attached to its outward face 296 with screws 298. Each plug 292 includes holes 300 through each of four sidewalls 302 that are used with screws and the holes of the beams 16, 18, 20 to secure the hub 288 to the beams 16, 18, 20.

The printed circuit boards 294 include positive and negative flat contacts 304, 306. The plugs 292 and the body 290 define an internal cavity 308. Positive and negative wires 310, 312 extend through the cavity 308 to interconnect the positive and negative flat contacts 304, 306.

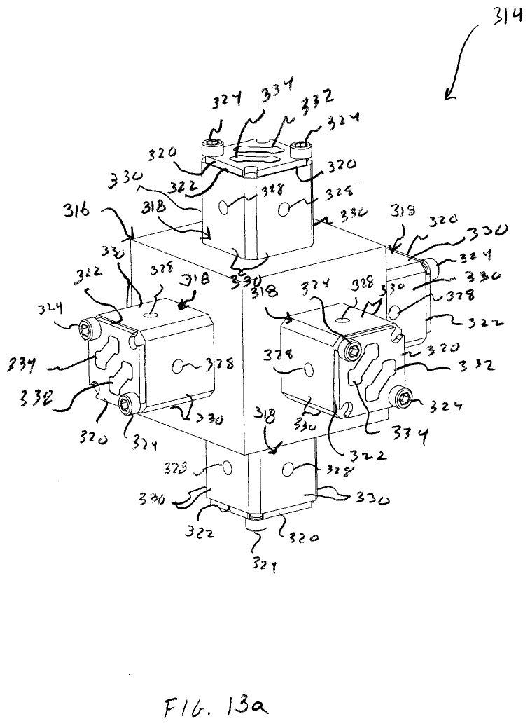

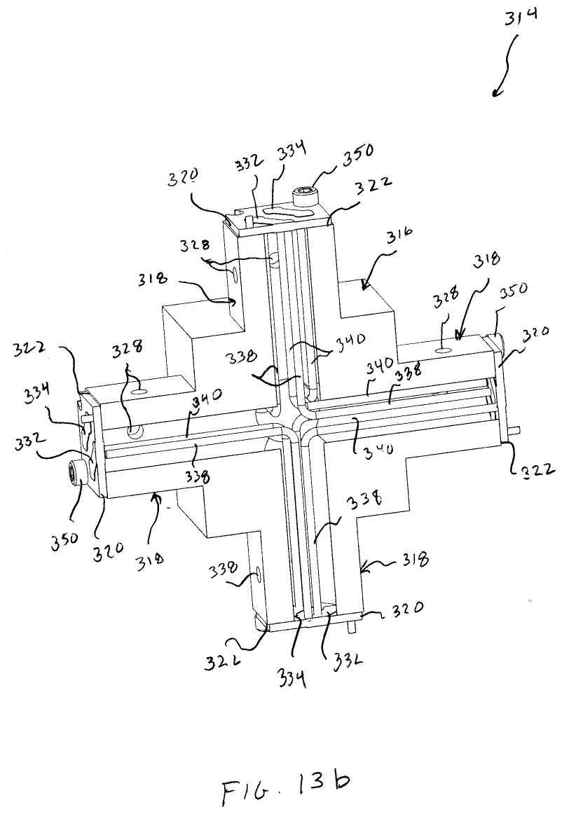

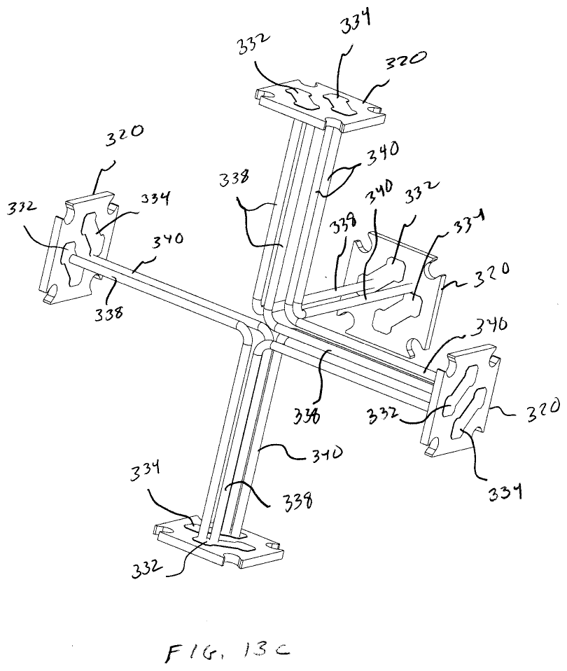

Regarding FIGS. 13a-13c, there is illustrated a five-connection hub 314. The five-connection hub 314 includes a rectangular body 316 supporting five plugs 318 extending from the body 316, each plug 318 being 90 degrees from another. The plugs 318 also are rectangular in shape. Each plug 318 includes a printed circuit board 320 attached to its outward face 322 with screws 324. Each plug 318 includes holes 328 through each of four sidewalls 332 that are used with screws and the holes of the beams 16, 18, 20 to secure the hub 314 to the beams 16, 18, 20.

The printed circuit boards 320 include positive and negative flat contacts 332, 334. The plugs 318 and the body 316 define an internal cavity 336. Positive and negative wires 338, 340 extend through the cavity 336 to interconnect the positive and negative flat contacts 332, 334.

As shown in FIGS. 14a-14c, there is illustrated the six-connection hub 36. The six-connection hub 36 includes a rectangular body 342 supporting five plugs 344 extending from the body 342, each plug 344 being 90 degrees from another. The plugs 344 also are rectangular in shape. Each plug 344 includes a printed circuit board 346 attached to its outward face 348 with screws 350. Each plug 344 includes holes 352 through each of four sidewalls 354 that are used with screws and the holes of the beams 16, 18, 20 to secure the hub 36 to the beams 16, 18, 20.

The printed circuit boards 346 include positive and negative flat contacts 356, 358. The plugs 344 and the body 342 define an internal cavity 360. Positive and negative wires 362, 364 extend through the cavity 360 to interconnect the positive and negative flat contacts 358, 360.

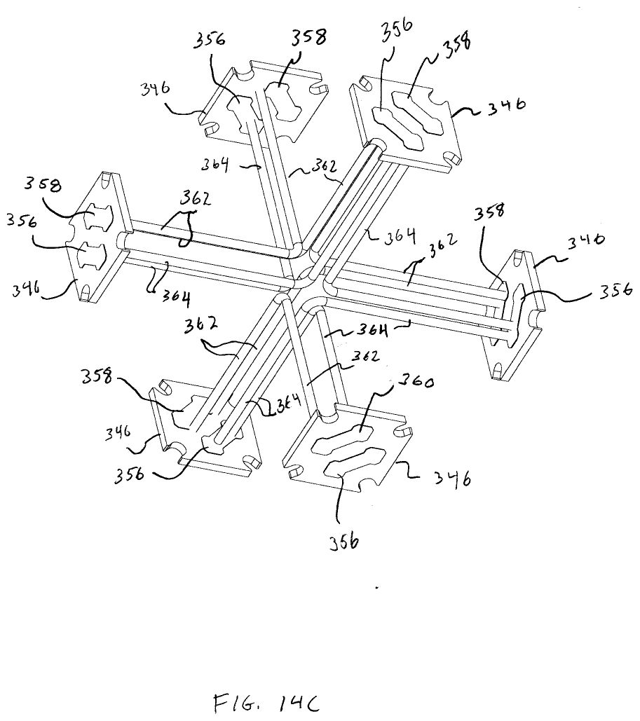

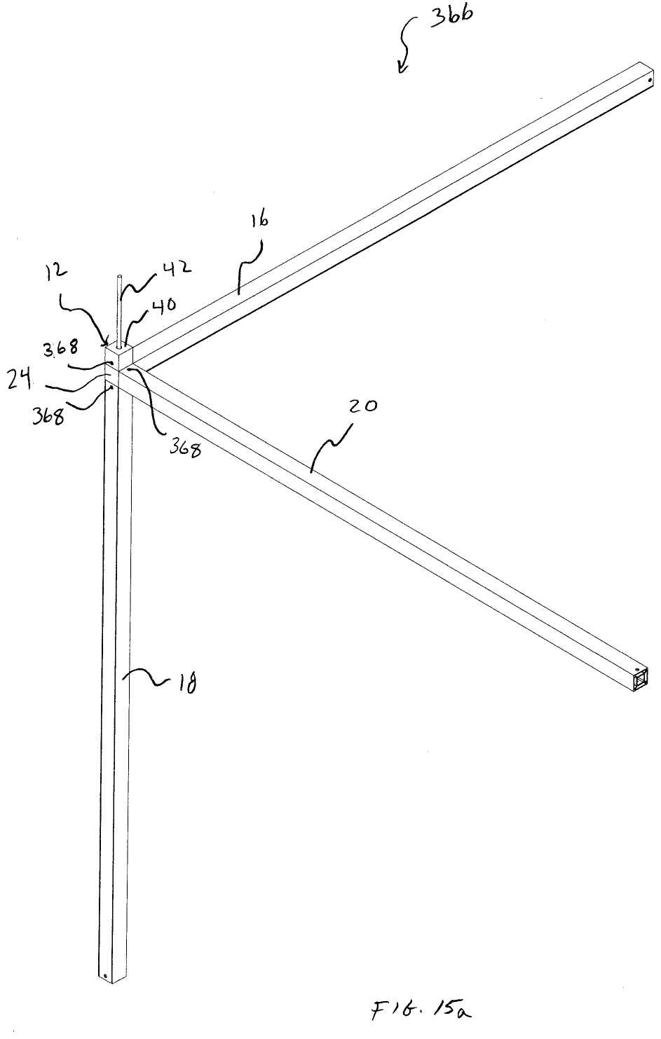

With reference to FIGS. 15a and 15b, there is shown a subassembly 366 of some of the components described above. The subassembly 366 includes the power supply hub 12, the single LED light beam 16, the dual LED light beam 18 and the non-lighted beam 20. The four-connection hub 24 interconnects these four components. One of the four plugs 266 of the four-connection hub 24 are each received in one of the sockets 44, 92, 128, 152 of the power supply hub 12, the single LED light beam 16, the dual LED light beam 18, and the non-lighted beam 20. The plugs 266 are held in their respective sockets 44, 92, 128, 152 using the aligned holes 60, 96, 132, 156 and screws 368.

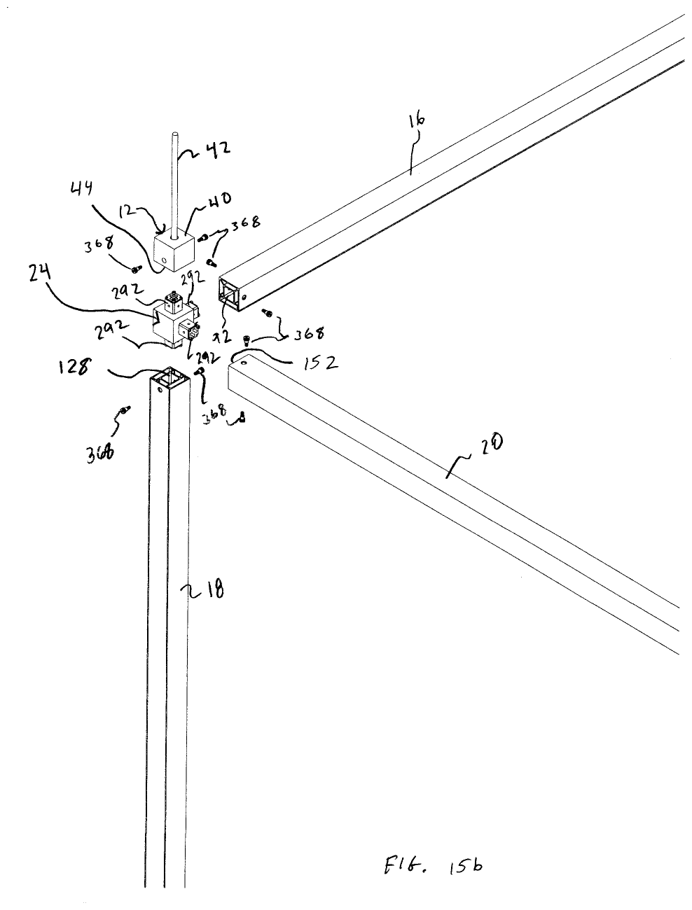

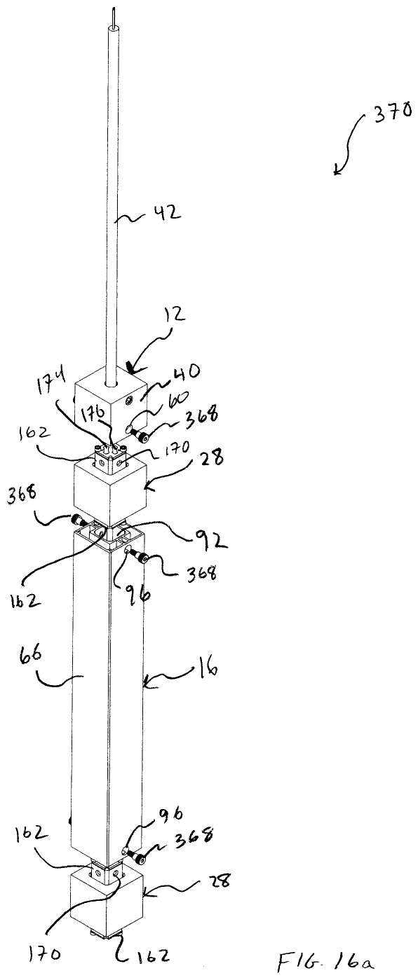

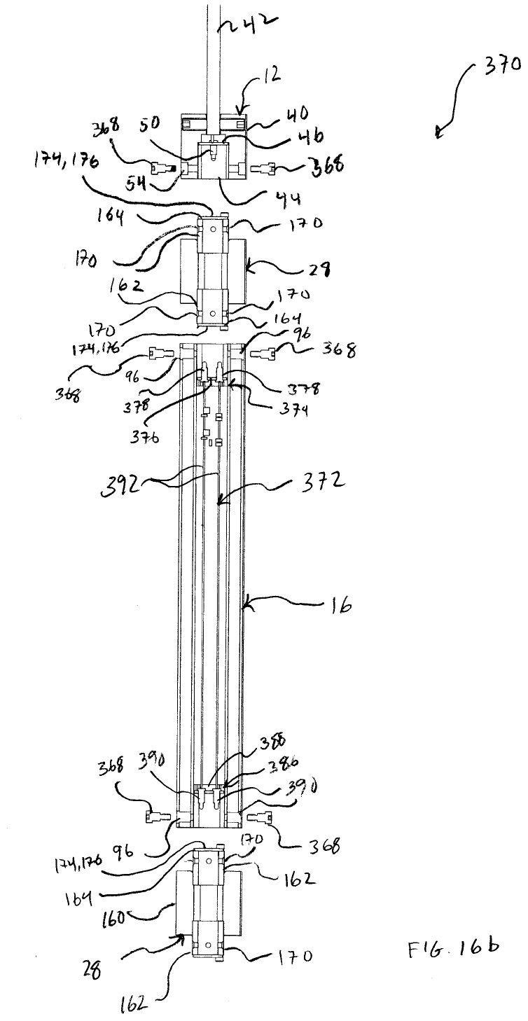

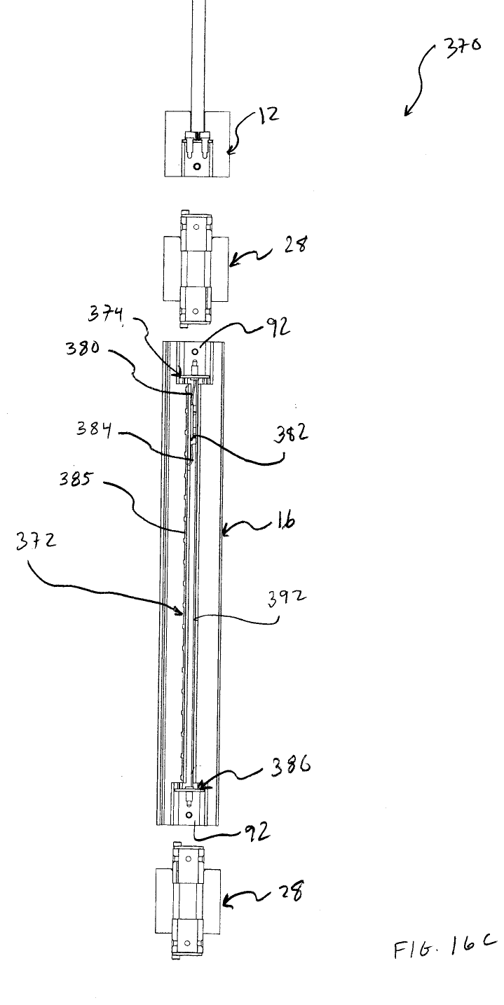

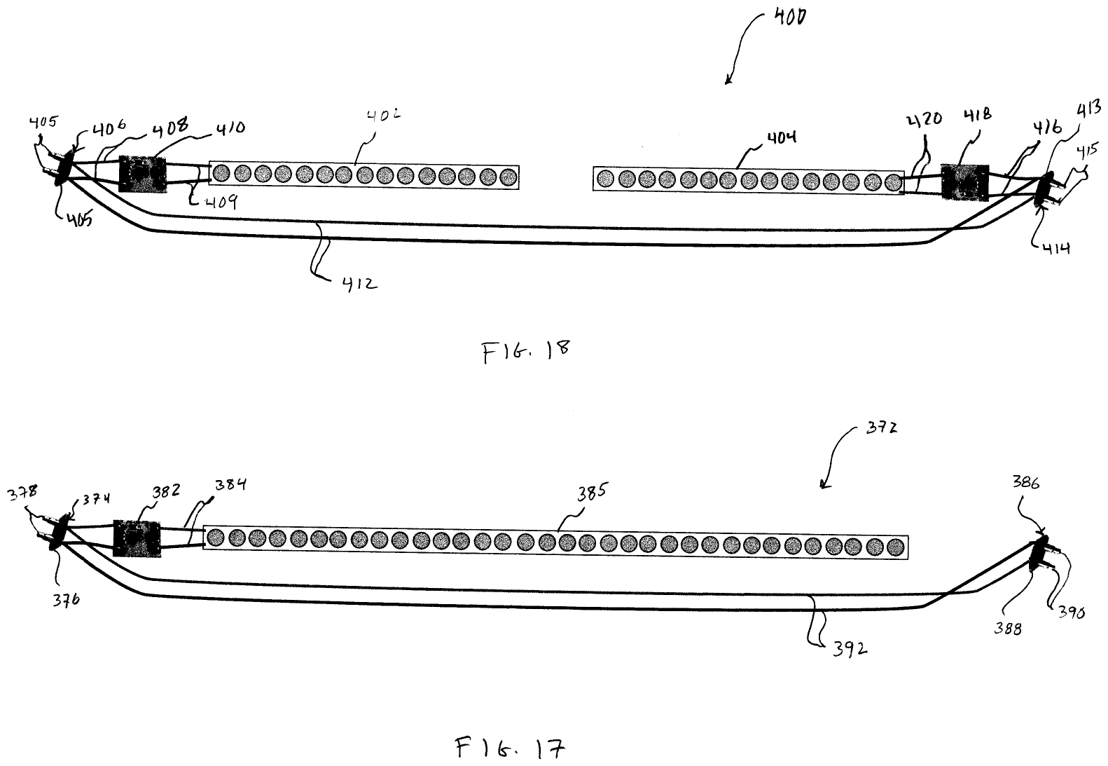

Regarding FIGS. 16a-16c, there is shown another subassembly 370 of some of the components described above. The subassembly 370 includes the power supply hub 12, the single LED light beam 16 and two two-connection hubs 28. One of the plugs 162 of one of the two-connection hubs 28 may be received by the socket 44 of the power supply hub 12 and held in the socket 44 using the holes 60, 170 and the screws 368. The pins 50 in the power supply hub 12 make electric contact with the contacts 174, 176 of the plug 162. The other plug 163 of the same two-connection hub 28 can be received in the socket 92 of the single LED light beam and held in place using the holes 96, 170 and the screws 368. The electrical contacts 174, 176 of this plug 162 make electric contact with pins 94 in the socket 92. The pins 94 are part of a single LED light harness, such as harness 372 shown in FIG. 17. The other end of the single LED light beam includes the same socket 92 that receives the plug 162 of the second two-connection hub 28. The plug 162 is held in the socket 92 using the holes 96, 170 and the screws 368. The contacts 174, 176 of this plug 162 engage the pins of a bypass wire, such as pins 390 of bypass wires 392 of the light harness 372 of FIGS. 17. Alternatively, light harness 400 may be used in the single LED light beam 16. The light harnesses 372, 400 are described further below with reference to FIGS. 17 and 18.

With reference to FIG. 17, there is illustrated the light harness 372 that was mentioned above. The light harness 372 includes a first pin connector 364 that includes a small circuit board 376 supporting pins 378. The small circuit board 376 is mounted in the socket 92 of one end of the elongated body 62 of the single LED light beam 16. Wires 380 electrically connect the pins 378 to a printed circuit board 382. The printed circuit board 382 includes electronics to provide a correct positive and negative output to a LED strip 385. The printed circuit board 382 includes a polarity and voltage circuit as explained below to ensure that the LED strip 385 receives the proper polarity and voltage (if the voltage is too high) regardless of the input polarity from the pins 378. Wires 384 electrically connect the printed circuit board 382 to the LED strip 385.

The light harness 372 includes a second pin connector 386. The second pin connector 386 includes a small circuit board 388 supporting pins 390. The small circuit board 376 is mounted in the socket 92 of the other end of the elongated body 62 of the single LED light beam 16. Bypass wires 392 electrically connect the first pin connector 374 to the second pin connector 386. This connection bypasses the LED 385 strip and creates a direct connection between the first and second pin connectors 374, 386. The benefit is that the voltage out of the second pin connector 386 is not reduced by any voltage drop created by the LED strip 385. It is well known that LED strips cause a voltage drop due to the resistance used to create the light. The longer the LED strip then the larger the voltage drop. If the voltage drops below the level need for the particular LED strip, then the strips will not illuminate as bright, and the LED elements farther from the power source also will be dimmer. The bypass configuration enables a second LED light strip to be used downstream of any upstream light strip without the negative effects of voltage drop.

As shown in FIG. 18, there is illustrated the alternative light harness 400 mentioned above. The light harness 400 includes two LED strips 402, 404. The light harness 400 has a first pin connector 406 with a small circuit board 403 supporting pins 405. The small circuit board 403 is mounted in the socket 92 of one end of the elongated body 62 of the single LED light beam 16. Wires 408 electrically connect the pins 405 to a first printed circuit board 410. The first printed circuit board 410 includes electronics to provide forward bias polarity regardless of the input polarity from the pins 405 and proper voltage (if the voltage is too high) for the first LED strip 402 on the same basis as discussed above for light harness 372. The electronics only reduce the input voltage to the required level for the LED strip and will not increase the voltage when it is too low. Wires 409 electrically connect the printed circuit board 410 to the first LED strip 402.

The light harness 400 includes a second pin connector 414 with a small circuit board 413 supporting pins 415. The small circuit board 413 is mounted in the socket 92 of the other end of the elongated body 62 of the single LED light beam 16. Bypass wires 412 electrically connect the first pin connector 406 to the second pin connector 414. This connection bypasses the first LED strip 402 and forms a direct connection between the first and second pin connectors 405, 414. Wires 416 electrically connect the second pin connector 414 to a second printed circuit board 418. The second printed circuit board 418 performs the same function as the first printed circuit board 410. That is, it includes electronics to provide a forward bias polarity and correct voltage (if the voltage is too high) the second LED strip 404 regardless of the input polarity from the bypass wires 412. Wires 420 electronically connect the printed circuit board 418 to the LED strip 404.

Because of the bypass wires 412, the pins 415 provide the same voltage output as that at the first pin connector 406. This enables the second LED light strip 404 and a LED light strip downstream of both the first and second LED light strips 402, 404 to be employed without the negative effects of voltage drop caused by the first and second LED light strips 402, 404. Too much voltage drop may cause any downstream LED strip to not illuminate to the required extent or to provide consistent illumination or to not operate at all.

With reference to FIG. 19, there is a light harness 422 that can be used with a dual LED light beam, such as light beam 18. The light harness 422 includes two LED strips 424, 426. The light harness 422 has a first pin connector 428 with a small circuit board 430 supporting pins 432. The small circuit board 430 is mounted in the socket 128 of one end of the elongated body 98 of the duel LED light beam 18. Wires 436 electrically connect the pins 432 to a first printed circuit board 434. Like previous printed circuit boards, the first printed circuit board 434 includes electronics to provide a proper polarity (forward bias) and correct voltage (if the voltage is too high) to the first LED strip 424. The printed circuit board 434 ensures that the LED strip 424 receives the proper polarity regardless of the input polarity from the pins 432. Wires 438 electrically connect the printed circuit board 434 to the first LED strip 424.

The light harness 422 includes a second pin connector 440 with a small circuit board 442 supporting pins 444. The small circuit board 442 is mounted in the socket 128 of the other end of the elongated body 98 of the dual LED light beam 18. Bypass wires 446 electrically connect the first pin connector 428 to the second pin connector 440. This connection bypasses the first LED strip 424 and forms a direct connection between the first and second pin connectors 428, 440.

Wires 450 electrically connect the second pin connector 440 to a second printed circuit board 448. The second printed circuit board 448 performs the same function as the first printed circuit board 434. That is, it includes electronics to provide a correct polarity (forward bias) and voltage (if the voltage is too high) out to the second LED strip 426 regardless of the input polarity and voltage from the bypass wires 446. Wires 452 electronically connect the printed circuit board 448 to the LED strip 426.

Because of the bypass wires 446, the pins 444 provide voltage that is not reduced by the first LED strip 424. This enables the second LED light strip 426 and a LED light strip downstream of both the first and second LED light strips 424, 426 to be employed without the negative effects of voltage drop. Too much voltage drop may cause any downstream LED strip to not operate properly or even at all, as explained above.

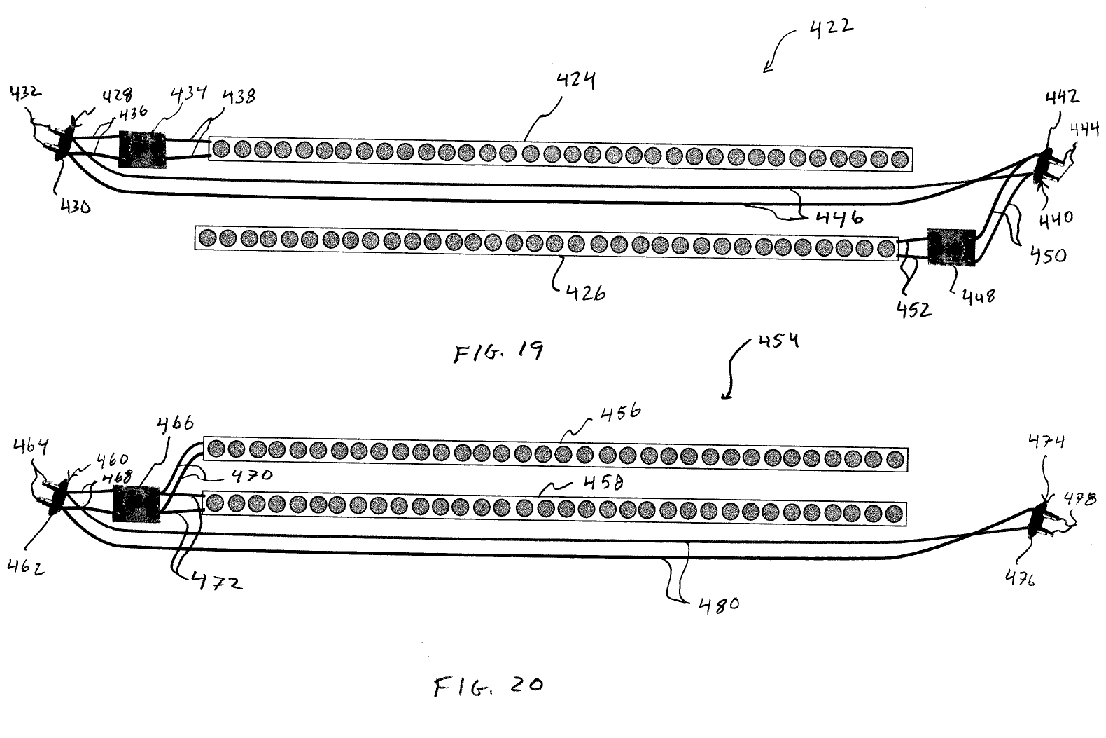

Regarding FIG. 20, there is illustrated an alternative light harness 454 that can be used with a dual LED light beam, such as light beam 18. The light harness 454 includes two LED strips 456, 458. The light harness 454 has a first pin connector 460 with a small circuit board 462 supporting pins 464. The small circuit board 462 is mounted in the socket 128 of one end of the elongated body 98 of the duel LED light beam 18. Wires 468 electrically connect the pins 464 to a printed circuit board 466. Like previous printed circuit boards, the printed circuit board 466 includes electronics to provide a proper polarity (forward bias) and correct voltage (if the voltage is too high) to the first LED strip 456 and the second LED strip 458. The printed circuit board 466 ensures that the LED strips 456, 458 receives the proper polarity and correct voltage regardless of the input polarity and voltage (if too high) from the pins 464. Wires 470 electrically connect the printed circuit board 466 to the first LED strip 456, and wires 472 electrically connect the printed circuit board 466 to the second LED strip 458.

The light harness 454 includes a second pin connector 474 with a small circuit board 476 supporting pins 478. The small circuit board 476 is mounted in the socket 128 of the other end of the elongated body 98 of the dual LED light beam 18. Bypass wires 480 electrically connect the first pin connector 460 to the second pin connector 474. This connection bypasses the first and second LED strips 456, 458 and forms a direct connection between the first and second pin connectors 460, 474.

Because of the bypass wires 480, the voltage at the pins 478 is not reduced by the first and second LED strips 456, 458. This enables a LED light strip downstream of both the first and second LED light strips 456, 458 to be employed without the negative effects of voltage drop. Too much voltage drop may cause any downstream LED strip to not operate properly or even at all, as explained above. The LED strips discussed herein such as LED strips 402, 404, 424, 426, 456, and 458 may be flexible LED strips that connect to the beams disclosed herein either via a fastener such as a screw or a rivet or via an adhesive. The LED strips 402, 404, 424, 426, 456, and 458 may alternatively be embodied as rigid structures, such as printed circuit boards, made primarily out of, for example, a fiberglass reinforced epoxy resin or a paper reinforced phenolic resin. The LED strips 402, 404, 424, 426, 456, and 458 in such a rigid configuration may be connected to the beams disclosed herein either via a fastener such as a screw or a rivet or via an adhesive.

The pins of the connectors discussed herein include a non-flat head because it has been found that the non-flat, and preferably a hemispherical, pin head profile provides superior connectivity over other pin structures in modular LED light fixtures, such as those described herein. They maintain a superior electrical connection with the pads under various installation conditions. The electrical connections between connecting elements and between connecting elements and light emitting diode lighting circuit devices in connection with the disclosed embodiments are achieved by mechanical contact between a pair of pins and a pair of pads, and that it is the mechanical contact between the pins and the pads that establishes the electrical connection that supplies power. Poor contact at any transfer junction compromises electrical power supplied to all transfer junctions electrically downstream of the transfer junction having poor contact, and thus, a proper connection is desired at each transfer junction so that the LED fixture operates at its intended capacity, including as a usefulness light source and as a decorative lighting fixture with aesthetic value. Thus, the length of pin and/or the bias of a spring pushing on the pin should be coordinated to ensure there is a good connection without damage to the pads. If the pin is too short and/or the spring is too weak, the connection may not be good. If the pin is too long, it may damage the pad and other interface. This is described further in U.S. Pat. No. 11,067,256 to Kinsley entitled “MODULAR LIGHT EMITTING DIODE FIXTURE HAVING ENHANCED INTERCONNECT PINS BETWEEN MODULAR COMPONENTS”, which is incorporated by reference in its entirety herein.

When the light harnesses are connected to a hub, the hub creates a voltage across the pins of the light harness that may be in either a forward bias or a reverse bias relative to the LED lighting. Without the polarity circuit, connecting the LED lighting to power supplied from a hub would run the risk of incorrectly installing the LED lighting, and thus, the LED lighting may end up connected in reverse bias. Installing LED lighting in a reverse bias may increase assembly time and risk burning out the LED lighting.

The polarity circuit described above prevents the LED lighting from receiving a voltage in a reversed bias by providing a forward bias voltage to the LED lighting regardless of polarity of the voltage input into the polarity circuit from the pins of the light harness. This is described further in U.S. Pat. No. 11,067,256 to Kinsley entitled “MODULAR LIGHT EMITTING DIODE FIXTURE HAVING ENHANCED INTERCONNECT PINS BETWEEN MODULAR COMPONENTS”, which is incorporated by reference in its entirety herein. Because of the polarity circuit on the printed circuit boards of the light harnesses, there is no possibility that the LED lighting receives a reverse polarity voltage based on the voltage provided across the input pins because the polarity of the LED lighting relative to the output of the polarity circuit is fixed as forward bias at the time of manufacture.

Further, the polarity circuit may be, for example, a CMOS polarity circuit or any other circuit configured to maintain a constant output voltage polarity regardless of the input voltage polarity. For example, a pair of PMOS and a pair of NMOS transistors may be configured to provide a constant output voltage polarity regardless of the input voltage polarity in a manner known to those of ordinary skilled in the art such as those disclosed in U.S. Pat. No. 4,139,880 to Ulmer et al. entitled “CMOS POLARITY REVERSAL CIRCUIT” which is hereby incorporated by reference in its entirety.

Those skilled in the art will recognize that a wide variety of modifications, alterations, and combinations can be made with respect to the above described embodiments without departing from the scope of the disclosure. Such modifications, alterations, and combinations are to be viewed as being within the ambit of the present disclosure.

What is claimed is:

1. A modular light element comprising:
a body with at least a first portion permitting light to pass through the body; and
a light harness disposed at least in part in the body and comprising,
a first light source having at least one light emitting diode,
a first electrical connector
a first polarity circuit connected electrically to the first electrical connector and the first light source, and
a second electrical connector electrically and directly connected to the first electrical connector so that power received at the first electrical connector bypasses the first light source.

2. The modular light element of claim 1 wherein the body is elongated with a first end opening and second end opening.

3. The modular light element of claim 2 wherein first electrical connector is disposed at the first end opening and the second electrical connector is disposed at the second end opening.

4. The modular light element of claim 3 wherein the first and second electrical connectors include at least two pins for transferring electrical current.

5. The modular light element of claim 1 further comprising a second polarity circuit connected electrically to the second electrical connector and a second light source connected electrically to the second polarity circuit.

6. The modular light element of claim 5 wherein the second light source is located outside the body.

7. The modular light element of claim further comprising a second light source connected electrically to the first polarity circuit.

8. The modular light element of claim 1 wherein the body is elongated, and the first portion extends along the body, and wherein the first light source comprises two or more light emitting diodes disposed in the longitudinal direction of the body.

9. A modular light fixture comprising:
a converter for converting alternating current to direct current for use by the modular light fixture;
a first connector electrically connected to the converter;
a second connector electrically connected to the first connector; and
a light element electrically connected to the second connector, the light element comprising,
a body,
a light harness disposed at least in part in the body and having a first light source having at least one light emitting diode, a third electrical connector, a first polarity circuit connected electrically to the third electrical connector and the first light source, and a fourth electrical connector electrically and directly connected to the third electrical connector so power received at the third electrical connector bypasses the first light source.

10. The modular light fixture of claim 9 wherein the body is elongated with a first end opening and second end opening.

11. The modular light fixture of claim 10 wherein third electrical connector is disposed at the first end opening and the fourth electrical connector is disposed at the second end opening.

12. The modular light element of claim 11 wherein the third and fourth electrical connectors include at least two pins for transferring electrical current.

13. The modular light element of claim 9 further comprising a second polarity circuit connected electrically to the fourth electrical connector and a second light source connected electrically to the second polarity circuit.

14. The modular light element of claim 13 wherein the second light source is located outside the body.

15. The modular light element of claim 9 further comprising a second light source connected electrically to the first polarity circuit.
